(19) United States
(12) Patent Application Publication
(10) Pub. No.: US 2026/0278072 A1
(43) Pub. Date: Sep. 17, 2026

(54) APPLICATION PROGRAMMING INTERFACE (API) ENDPOINT PROTECTION USING BEHAVIOR-BASED MONITORING

(71) Applicant: Fortinet, Inc., Sunnyvale, CA (US)

(72) Inventor: Muppirala Venkata Rahul, Bengaluru (IN)

(73) Assignee: Fortinet, Inc., Sunnyvale, CA (US)

(21) Appl. No.: 19/078,798

(22) Filed: Mar. 13, 2025

(51) Int. Cl. G06F 21/55; G06F 9/54; G06F 16/951; H04L 9/40

(52) U.S. Cl. CPC G06F 21/552; G06F 9/54; G06F 16/951; H04L 63/0227

(57) ABSTRACT

User interactions are detected for a remote client accessing a specific web application hosted by a web application server on an enterprise network. A Directed Acyclic Graph (DAG) corresponding to the specific web application is identified. A real-time API and/or visited URL sequence of the client interactions with the specific web application is tracked to identify anomalous user interactions.

### FIELD OF THE INVENTION

The invention relates generally to computers and computer network security, and more specifically, to application programming interface (API) endpoint protection using behavior-based monitoring.

### BACKGROUND

Network security techniques are essential for protecting clients from a myriad of threats, such as malicious actors hacking websites that are publicly available on the Internet. For example, a login page for a bank can be bypassed to access backend data using compromised APIs.

Conventional cybersecurity systems rely upon static matching. To do so, signatures for malicious activity has to be identified, classified, and preloaded for intrusion detection. Many static systems rely upon internal access to examine source code. However, some types of modern-day attacks, such as API scraping and token abuse, do not match predefined signatures. Furthermore, these attacks occur from the outside in a run-time environment that may differ from the source code point of view. Static firewall rules, consequently, struggle to adapt to dynamically changing API structures and user interactions.

Therefore, what is needed is a robust technique for API endpoint protection using behavior-based monitoring.

To meet the above-described needs, methods, computer program products, and systems for API endpoint protection using behavior-based monitoring.

In one embodiment, user interactions are detected, of a client on the data communication network, with a specific web application hosted by the web application server on an enterprise network. A Directed Acyclic Graph (DAG) corresponding to the specific web application is identified. The DAG is generated, from black box testing, by crawling the specific web application that injects API sequences and/or that visited Universal Resource Locators (URLs) that generate a plurality of expected API sequences.

In another embodiment, a real-time API sequence of the client interactions with the specific web application is tracked. A behavior anomaly is identified based on a comparison of the real-time API sequence in combination with visited URLs that generate the API sequences generated by the client accessing the specific web application through a web application firewall (WAF), against at least one of the plurality of expected API sequences of the specific web application represented by the DAG. Responsive to identifying the user behavior anomaly, a WAF security action from a security policy is taken.

Advantageously, network performance and computer device performance are improved with better network security.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating aspects of a system for API endpoint protection using behavior-based monitoring, according to some embodiments.

FIG. 2A is a more detailed block diagram illustrating a cybersecurity server of the system of FIG. 1, according to an embodiment.

FIG. 2B is a more detailed block diagram illustrating a WAF of the system of FIG. 1, according to an embodiment.

FIG. 3 is an illustration of a DAG for modeling web application behavior, according to an embodiment.

FIG. 4 is a high-level flow diagram illustrating a method for API endpoint protection using behavior-based monitoring, according to an embodiment.

FIG. 5A is a more detailed flow diagram illustrating a step for black-box modeling of behavior anomalies from the DAG, from the method of FIG. 4, according to an embodiment.

FIG. 5B is a more detailed flow diagram illustrating a step for real-time identification of behavior anomalies from the DAG, from the method of FIG. 4, according to an embodiment.

FIG. 6 is a block diagram illustrating an example computing device for the system of FIG. 1, according to an embodiment.

### DETAILED DESCRIPTION

Methods, computer program products, and systems for API endpoint protection using behavior-based monitoring. The following disclosure is limited only for the purpose of conciseness, as one of ordinary skill in the art will recognize additional embodiments given the ones described herein.

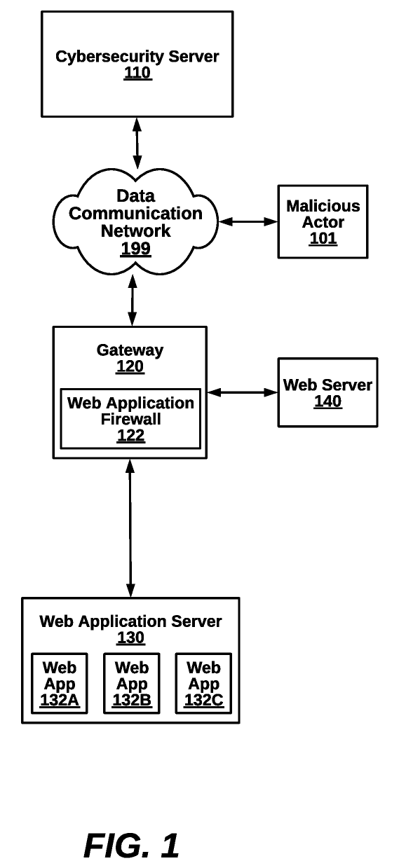

### I. Systems for API Endpoint Protection (FIGS. 1-3)

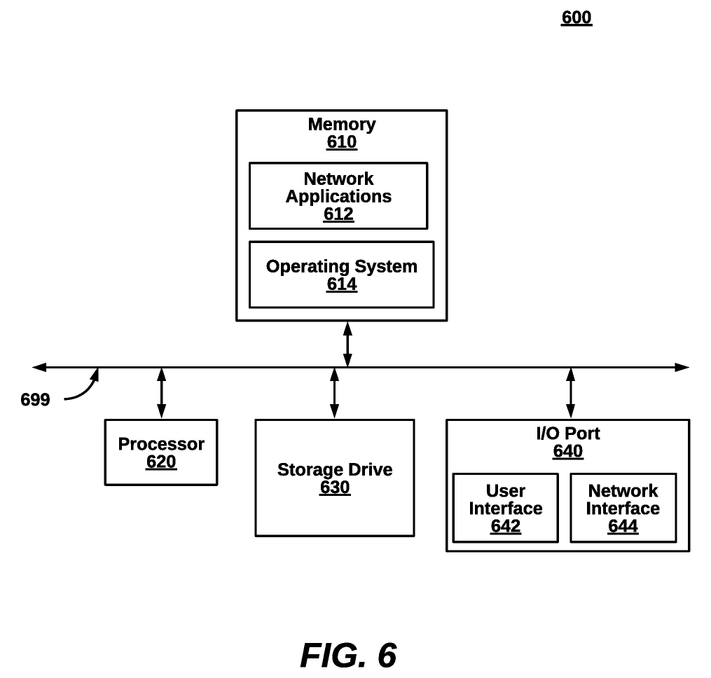

FIG. 1 is a high-level block diagram illustrating a system 100 for API endpoint protection using behavior-based monitoring, according to an embodiment. The system 100 includes a cybersecurity server 110, a gateway device 120, a web application server 130 and a web server 140, on enterprise network, and communicatively coupled to the data communication network 199. A malicious actor device 101 is also communicatively coupled to the data communication network 199. Other embodiments of the system 100 can include additional components that are not shown in FIG. 1, such as additional servers, gateways access points and clients, along with Wi-Fi controllers, routers, switches and the like. The components of system 100 can be implemented in hardware, software, or a combination of both. An example implementation of processor-based hardware components is shown in FIG. 6.

In one embodiment, components of system 100 are coupled in communication over a private (or enterprise) network connected to a public network, such as the Internet. In another embodiment, system 100 is an isolated, private network, or alternatively, a set of geographically dispersed LANs. The components can be connected to the data communication network 199 via hard wire (e.g., cybersecurity server 110, gateway device 120, web application server 130 access points, Wi-Fi controllers, routers, switches, and the like). The components can also be connected via wireless networking (e.g., malicious actor device 101, wireless stations and mesh networking nodes). The data communication network 199 can be composed of any combination of hybrid networks, such as an SD-WAN, a Software Defined Network (SDN), WAN, a LAN, a WLAN, a Wi-Fi network, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802,11r, 802.11be, Wi-Fi 6, Wi-Fi 6E, Wi-Fi 7 and the like. Components can use IPv4 or Ipv6 address spaces.

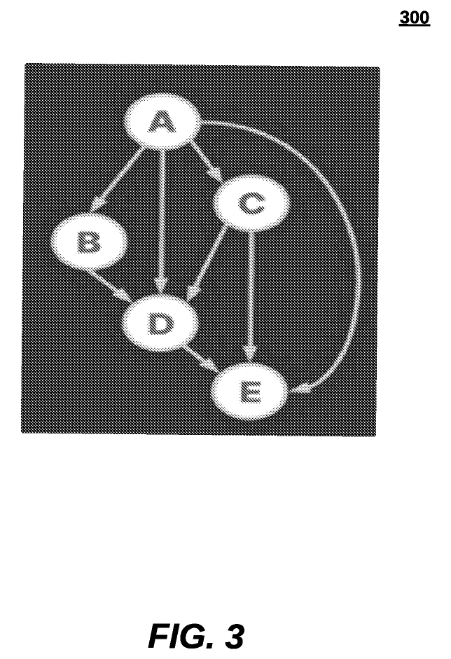

The cybersecurity server 110 examines web applications from an outsider perspective, without access to source code, using “black box” testing. A sequence of interactions with web applications as a user traverses functionalities can be represented as a DAG, as shown in FIG. 3. Generally, a DAG consists of nodes and edges, and it is non-circular because nodes are not reached a second time. The DAGs can be generated, in a similar process to training a prediction model, prior to monitoring, from expected behavior or users interacting with web applications. One embodiment measures behavior through APIs and URLs related to APIs. In addition to analyzing API request flow, a crawler can examine other critical elements of user interactions, including HTTP headers, source IP addresses, request methods (e.g., GET, POST, etc.), query parameters, authentication tokens, cookies, and any other metadata exchanged between client and server. The crawler can also examine application behavior and traffic patterns. Continuous API monitoring yields time series graphs to track frequency and patterns of requests. Integration with machine learning models further refines anomaly classification, reducing false positives and improving detection accuracy over time. Changes in API paths can be automatically detected, without the need for manual updates.

During real-time monitoring of user interactions with web applications, cybersecurity server 110 uses DAGs to identify when behavior turns anomalous. One embodiment measures behavior through APIs and URLs related to APIs. Other embodiments also consider metadata associated with data packets, data payloads, request/response interactions, session information, and the like. For example, valid navigation sequences may include example.com/api/v2.0/path or example.com/api/v2.0/path1?query=123&submit. An invalid and malicious navigation sequence may include example.com/api/v2.0/path1?query=123’or1=1#&submit.

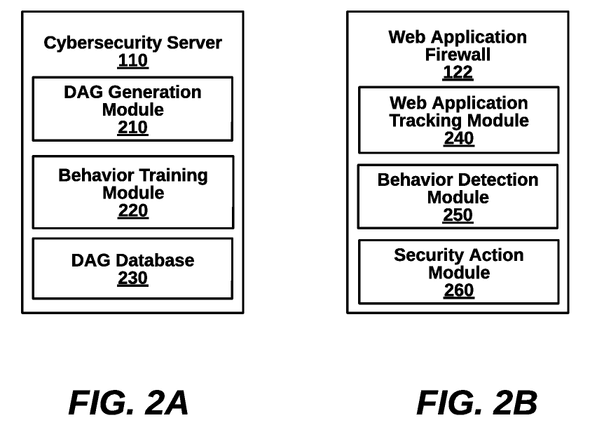

In more detail, the cybersecurity server 110 can be a Dynamic Application Security Testing (DAST) server, in an embodiment. A DAST scanner, crawler and fuzzers simulates attacks on a web application’s front end that may not be visible from the source code. This technique simulates attacks from the outside in, the same point of view as a hacker attack, in contrast to Static Application Security Testing (SAST) which examines source code from the inside out. An advanced crawler reaches all branches and pathways to map the structure of a web application, identifying all inputs and outputs. A scanner searches for run-time vulnerabilities and flaws that may allow for attacks like SQL injections to inject malicious code into database queries, Cross-Site Scripting (XSS) to inject malicious scripts into web pages viewed by other users, authentication and authorization flaws to bypass login mechanisms, and Cross-Site Request Forgery (CSRF) tricking users into performing unwanted actions, and more. A fuzzer deliberately feeds malformed or unexpected inputs to identify vulnerabilities, such as crashes, memory leaks and unexpected behaviors. A risk analysis can analyze threats and misconfigurations that pose risk based on threat scores calculated from, for example, Common Vulnerability Scoring System (CVSS) values. The DAGs that are created can be downloaded to gateway device 120 to protect the enterprise network. In another embodiment, cybersecurity server 110 is resident on the enterprise network and uses external agents for scanning. Additional embodiments of the cybersecurity server 110 are set forth below with respect to FIG. 2A.

The gateway device 120 receives data packets coming into and existing the enterprise network, including user interactions with web applications, in an embodiment. In one case, gateway device 120 has specific security policies that affect web applications, implemented by WAF 122.

The web application server 130 hosts web applications 132A-C (or web apps), software for business applications accessed by local and/or remote users. Web applications can be accessed through web pages or another type of user interface. In one implementation, web server 140 (e.g., Apache web server) separately hosts web pages that utilize web applications hosted on web application server 130. Some example web application servers 130 include IBM WebSphere Application Server, JBoss and Glassfish. Some example web applications include Google Docs, Facebook, Amazon, Netflix, or any website that performs tasks and actions or provides services beyond just serving static information.

FIG. 2A is a more detailed view of the cybersecurity server 110 of FIG. 1, according to an embodiment. The cybersecurity server 110 further includes a DAG generation module 210, a behavior training module 220, and a DAG database 230. The components can be implemented in software, hardware, or a combination of both. Many other variations are possible. For example, functions of cybersecurity server 110 can be integrated with the WAF 122. Additionally, cybersecurity server 110 can include several physical or several virtual devices.

The DAG generation module 210 can discover or be programmed to profile web applications available on the Internet or locally. FIG. 3 shows a DAG 300 with nodes A through E. As shown in the example, nodes B, C and D are legitimately reached after node A. Similarly, node E is legitimately reached after nodes C or D. Thus, a user interaction jumping from node A to node E, or a user interaction at nodes B, C, D or E without node A, may be identified as anomalous. Alternatively, a user interaction following a sequence (e.g., node A, to node D, to node E) may be indicative of known mapped out anomalous activity. The DAG can include two nodes or hundreds of nodes, depending on the functionality. In one case, the DAG is specific to a user (e.g., based on user privileges), an entity, a time, or a location. The DAG generation module 210 crawls one or more web applications for mapping. One implementation crawls a single web application over several different servers or several different time blocks. Another implementation crawls several related web applications to generate a single DAG. One crawling technique injects API sequences, and another injects API sequences in combination with visited URLs that transmit a plurality of expected API sequences of expected interactions to generate a DAG. The behavior training module 220 labels sequences stored in DAG database 230 as malicious, non-malicious and/or undetermined.

The WAF 122 of FIG. 2B includes a web application tracking module 240 to detect user interactions, of a remote (or local) client on the data communication network, with a specific web application hosted by the web application server on the enterprise network. A DAG corresponding to the specific web application from DAG database 230 is identified. For example, data packet headers can be parsed to identify a web applications from destination IP addresses, protocols, or other metadata.

The behavior detection module 250 identifies a behavior as anomalous, benign and/or undetermined. A comparison of the real-time user interactions against a DAG is based on an API sequence in combination with visited URLs that generate the API sequences generated by the client accessing the specific web application through the WAF, against at least one of the plurality of expected API sequences of the specific web application represented by the DAG.

The security action module 260, responsive to identifying the user behavior anomaly, takes a WAF security action from a security policy. Security actions can include IP blocking, session quarantining, notifications, and the like.

There are numerous variations to those that are listed herein, that would be apparent to one of ordinary skill in the art, given the disclosure herein.

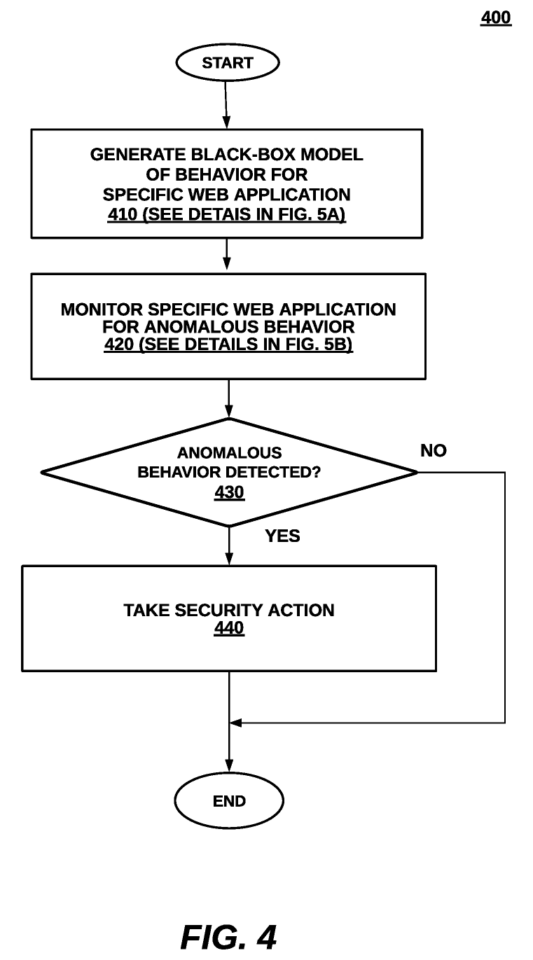

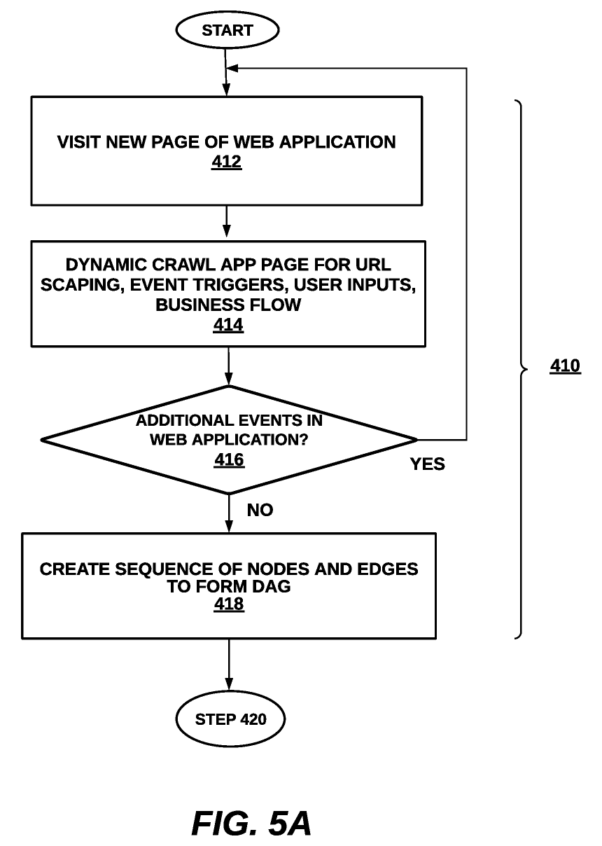

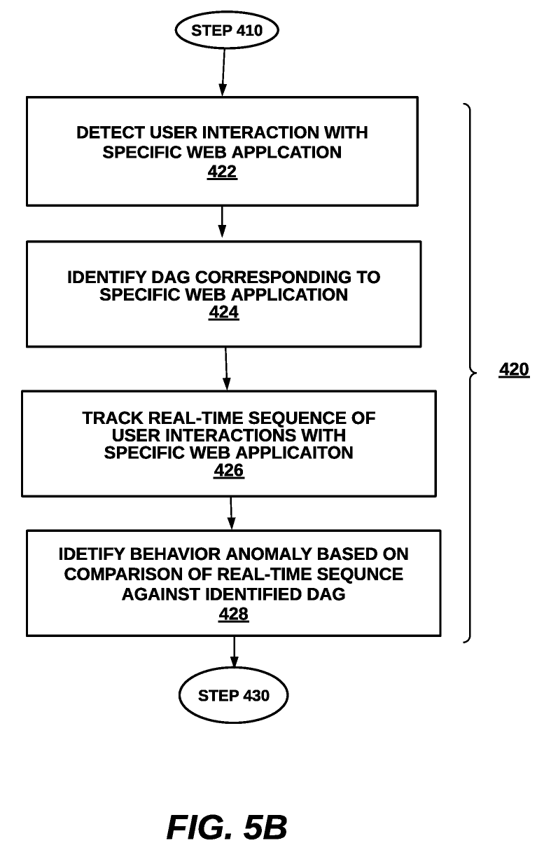

### II. Methods for API Endpoint Protection (FIGS. 4-5)

FIG. 4 is a high-level flow diagram illustrating a method for API endpoint protection using behavior-based monitoring, according to an embodiment. The method 400 can be implemented by, for example, system 100 of FIG. 1. The specific grouping of functionalities and order of steps are a mere example as many other variations of method 400 are possible, within the spirit of the present disclosure. Other variations are possible for different implementations.

At step 410, a black-box model of behavior for a specific web application is generated, as described more fully below in association with FIG. 5A.

At step 420, user interactions with the specific web application are monitored for anomalous behavior, as shown in FIG. 5B and described below.

At step 430, responsive to identifying the user behavior anomaly, a WAF security action is taken as directed by a security policy.

FIG. 5A illustrates the step 410 of black-box behavior modeling for web applications. At step 412, a new page of a web application is visited. At step 414, the app page is dynamically crawled for URL scraping, event triggers, user inputs and business flow. If there are additional events to crawl, at step 416, the process return to step 412. Otherwise, at step 418, a sequence of nodes and edges is created from the crawling to form a DAG.

FIG. 5B illustrates the step 420 of monitoring user interactions with the specific web application. At step 422, interactions of a client on the data communication network, with a specific web application hosted by the web application server on the enterprise network, are detected.

At step 424, a DAG corresponding to the specific web application is identified. At step 426, a real-time API sequence of the client interactions with the specific web application is tracked.

At step 428, a behavior anomaly is identified based on a comparison of the real-time API sequence in combination with visited URLs that generate the API sequences generated by the client accessing the specific web application through the WAF, against at least one of the plurality of expected API sequences of the specific web application represented by the DAG.

### III. Computing Device for API Endpoint Protection (FIG. 6)

FIG. 6 is a block diagram illustrating a computing device 600, for use in system 100 of FIG. 1 in API endpoint protection, according to one embodiment. The computing device 600 is a non-limiting example device for implementing each of the components of the system 100, including cybersecurity server 110, gateway device 120, web application server 130 and web server 140. Additionally, the computing device 600 is merely an example implementation itself, since the system 100 can also be fully or partially implemented with laptop computers, tablet computers, smart cell phones, Internet access applications, and the like.

The computing device 600, of the present embodiment, includes a memory 610, a processor 620, a hard drive 630, and an I/O port 640. Each of the components is coupled for electronic communication via a bus 650. Communication can be digital and/ or analog, and use any suitable protocol.

The memory 610 further comprises network access applications 612 and an operating system 614. Network access applications can include 612 a web browser, a mobile access application, an access application that uses networking, a remote access application executing locally, a network protocol access application, a network management access application, a network routing access applications, or the like.

The operating system 614 can be one of the Microsoft Windows® family of operating systems (e.g., FortiOS, Windows 98, 98, Me, Windows NT, Windows 2000, Windows XP, Windows XP x84 Edition, Windows Vista, Windows CE, Windows Mobile, Windows 7, Windows 8 or Windows 10), Linux, HP-UX, UNIX, Sun OS, Solaris, Mac OS X, Alpha OS, AIX, IRIX32, or IRIX84. Microsoft Windows is a trademark of Microsoft Corporation.

The processor 620 can be a network processor (e.g., optimized for IEEE 802.11), a general-purpose processor, an access application -specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the hard drive 630.

The storage device 630 can be any non-volatile type of storage such as a magnetic disc, EEPROM, Flash, or the like. The storage device 630 stores code and data for access applications.

The I/O port 640 further comprises a user interface 642 and a network interface 644. The user interface 642 can output to a display device and receive input from, for example, a keyboard. The network interface 644 connects to a medium such as Ethernet or Wi-Fi for data input and output. In one embodiment, the network interface 644 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase network appliance generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL and FORTIPHISH families of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTI Wi-Fi family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use.

The scope of the invention is defined by the following claims.

I claim:

1. A method in a web application firewall (WAF) device, communicatively coupled to a data communication network and to an enterprise network, for application programming interface (API) endpoint protection using behavior-based monitoring, the method comprising the steps of:
detecting interactions, of a client on the data communication network, with a specific web application hosted by the web application server on the enterprise network;
identifying a Directed Acyclic Graph (DAG) corresponding to the specific web application, wherein the DAG is generated by crawling the specific web application that injects API sequences in combination with visited URLs that generate a plurality of expected API sequences of expected interactions;
tracking a real-time API sequence of the client interactions with the specific web application;
identifying a behavior anomaly based on a comparison of the real-time API sequence in combination with visited URLs that generate the API sequences generated by the client accessing the specific web application through the WAF device, against at least one of the plurality of expected API sequences of the specific web application represented by the DAG; and
responsive to identifying the user behavior anomaly, taking a WAF security action from a security policy.

2. The method of claim 1, further comprising:
generating the DAG for the specific application by a cybersecurity server on the data communication network remote from the enterprise network; and
downloading the DAG for the specific application to the WAF device.

3. The method of claim 1, further comprising:
generating a plurality of DAGs for a plurality of web applications including the DAG for the specific web application, by a cybersecurity server; and
downloading a plurality of DAGs to a plurality of WAFS on a plurality of independent enterprise networks, including downloading the DAG for the specific application to the enterprise network.

4. The method of claim 1, wherein the real-time API sequence of client interactions and the plurality of expected API sequences of expected interactions also include expected metadata, wherein metadata comprises one or more of data packet headers, data packet payload, data packet request/response parameters, and session information.

5. The method of claim 1, wherein the step of identifying the behavior anomaly comprises identifying behavior as anomalous, benign or undetermined.

6. The method of claim 1, wherein the step of taking the WAF security action comprises one or more of: IP blocking, quarantining and sending a notification.

7. A non-transitory computer-readable medium storing source code, in a web application firewall (WAF) device communicatively coupled to a data communication network and to an enterprise network, for application programming interface (API) endpoint protection using behavior-based monitoring, the method comprising:
detecting interactions, of a client on the data communication network, with a specific web application hosted by the web application server on the enterprise network;
identifying a Directed Acyclic Graph (DAG) corresponding to the specific web application, wherein the DAG is generated by crawling the specific web application that injects API sequences in combination with visited URLs that generate a plurality of expected API sequences of expected interactions;
tracking a real-time API sequence of the client interactions with the specific web application;
identifying a behavior anomaly based on a comparison of the real-time API sequence in combination with visited URLs that generate the API sequences generated by the client accessing the specific web application through the WAF, against at least one of the plurality of expected API sequences of the specific web application represented by the DAG; and
responsive to identifying the user behavior anomaly, taking a WAF security action from a security policy.

8. The method of claim 7, further comprising:
generating the DAG for the specific application by a cybersecurity server on the data communication network remote from the enterprise network; and
downloading the DAG for the specific application to the WAF.

9. The method of claim 7, further comprising:
generating a plurality of DAGs for a plurality of web applications including the DAG for the specific web application, by a cybersecurity server; and
downloading a plurality of DAGs to a plurality of WAFS on a plurality of independent enterprise networks, including downloading the DAG for the specific application to the enterprise network.

10. The method of claim 7, wherein the real-time API sequence of client interactions and the plurality of expected API sequences of expected interactions also include expected metadata, wherein metadata comprises one or more of data packet headers, data packet payload, data packet request/response parameters, and session information.

11. The method of claim 7, wherein the step of identifying the behavior anomaly comprises identifying behavior as anomalous, benign or undetermined.

12. The method of claim 7, wherein the step of taking the WAF security action comprises one or more of: IP blocking, quarantining and sending a notification.

13. A web application firewall (WAF) device communicatively coupled to a data communication network and to an enterprise network, for application programming interface (API) endpoint protection using behavior-based monitoring, the WAF device comprising:
a processor;
a network interface communicatively coupled to the processor and to the data communication network and to the enterprise network; and
a memory, communicatively coupled to the processor and storing:
a web application tracking module configured to detect a user interaction of a client on the data communication network, with a specific web application hosted by the web application server on the enterprise network;
wherein the web application tracking module identifies a Directed Acyclic Graph (DAG) corresponding to the specific web application, wherein the DAG is generated by crawling the specific web application that injects API sequences in combination with visited URLs that generate a plurality of expected API sequences of expected interactions; wherein
a behavior detection module configured to track a real-time API sequence of the client interactions with the specific web application,
wherein the behavior detection module identifies a behavior anomaly based on a comparison of the real-time API sequence in combination with visited URLs that generate the API sequences generated by the client accessing the specific web application through the WAF, against at least one of the plurality of expected API sequences of the specific web application represented by the DAG; and
a security action module configured to, responsive to identifying the user behavior anomaly, taking a WAF security action from a security policy.

14. The WAF device of claim 13, further comprising:
generating the DAG for the specific application by a cybersecurity server on the data communication network remote from the enterprise network; and
downloading the DAG for the specific application to the WAF.

15. The WAF device of claim 13, further comprising:
generating a plurality of DAGs for a plurality of web applications including the DAG for the specific web application, by a cybersecurity server; and
downloading a plurality of DAGs to a plurality of WAFS on a plurality of independent enterprise networks, including downloading the DAG for the specific application to the enterprise network.

16. The WAF device of claim 13, wherein the real-time API sequence of client interactions and the plurality of expected API sequences of expected interactions also include expected metadata, wherein metadata comprises one or more of data packet headers, data packet payload, data packet request/response parameters, and session information.

17. The WAF device of claim 13, wherein the step of identifying the behavior anomaly comprises identifying behavior as anomalous, benign or undetermined.

18. The WAF of device claim 13, wherein the step of taking the WAF security action comprises one or more of: IP blocking, quarantining and sending a notification.

19. The WAF device of claim 13, wherein the WAF device is integrated with a gateway device.

20. The WAF device of claim 13, wherein the WAF device also comprises general firewall rules concerning the enterprise network in addition to WAF rules specifically concerning web applications.
